(19) United States
(12) Patent Application Publication
(10) Pub. No.: US 2026/0042695 A1
(43) Pub. Date: Feb. 12, 2026

(54) Glass-Ceramic Material

(71) Applicant: Liverpool John Moores University, Liverpool (GB)

(72) Inventors: Monower SADIQUE, Liverpool (GB); Abdullah KADHIM, Liverpool (GB)

(21) Appl. No.: 19/119,562

(22) PCT Filed: Oct. 10, 2023
(86) PCT No.: PCT/GB2023/052628

§ 371 Date: Apr. 9, 2025

(30) Foreign Application Priority Data
Oct. 10, 2022 (GB) 2214915.7

(51) Int. Cl. C03B 32/02

(52) U.S. Cl. CPC C03B 32/02; C03B 2201/32

(57) ABSTRACT

A method of preparing a glass-ceramic material, the method comprising the steps of:
(a) admixing a crystallisation promoter and a glass; wherein the glass has a median particle distribution (D₅₀) of from 50 to 70 μm; and
(b) sintering the admixture obtained in step (a).

A glass-ceramic material and the use of such a glass-ceramic material are also described.

### FIELD

The present invention relates to a method for forming a glass-ceramic material and to a glass-ceramic material. In particular, the present invention relates to compositions and methods that make use of a glass having a median particle distribution (D₅₀) of from 50 to 70 μm and a crystallisation promoter. The present invention also relates to the use of a glass-ceramic material in construction.

### BACKGROUND

Glass-ceramic (GC) materials are classified as lying between glasses and polycrystalline materials. GC materials have the same chemical composition as glasses but differ from them in that they are typically 95 to 98% crystalline by volume, with only a small percentage amorphous. GC materials are typically produced by converting the amorphous glass grains into a crystalline glass-ceramic material. Therefore, GC materials typically comprise one or more glass phases and one or more crystalline phases.

GC materials have attracted considerable scientific and commercial interest in many technological areas because of their unique and advantageous mechanical, thermal, chemical, durable and electrical properties. They also allow for varieties of compositions and microstructures with specific technological properties and so can be used in a wide range of applications.

Glass-ceramic components are usually formed using the same processes that are applicable to glass components. Amorphous glass material may be converted into a crystalline glass ceramic material following heat treatment or devitrification. Devitrification can occur spontaneously during cooling or in service. It involves heating the formed glass product to a temperature high enough to stimulate crystals to nucleate throughout the glass. The process of converting amorphous glasses into crystalline structures usually occurs with the aid of nucleating agents or sintering agents such as TiO₂, B₂O₃ and Li₂O. Another role for the nucleating agents is to reduce the crystallisation temperature.

GC materials are usually synthesised using pure oxides, which typically provides structures that are pore-free, dense, and homogeneous. For example, pure chemical compounds are typically used, such as fluorapatite, anorthite, diopside, quartz, granite, magnesite and bauxite. This increases the cost of the GC materials. The conventional method of forming GCs involves many stages with the addition of nucleating agents necessary in order to reach appropriate nucleation and crystallisation. Nucleating agents are considered expensive raw materials in addition to their lack of availability. Furthermore, these synthesising methods usually utilise very high temperatures (higher than 1000° C.) over a long time, such as for 24 hours or more.

Current methods of synthesising GC materials therefore have a number of disadvantages such as the expense of the raw materials and the energy cost of the use of temperatures in excess of 1000° C.

There is therefore a need to provide alternative methods for synthesising glass-ceramic materials which make use of less expensive raw materials and/or do not require high temperature synthesis conditions.

### SUMMARY OF THE INVENTION

According to aspects of the present invention, there are provided a method of preparing a glass-ceramic material, a glass-ceramic material, and structures prepared from the glass-ceramic material as set forth in the appended claims. Other features of the invention will be apparent from the dependent claims, and from the description which follows.

According to a first aspect of the present invention, there is provided a method of preparing a glass-ceramic material, the method comprising the steps of:
(a) admixing a crystallisation promoter and a glass; wherein the glass has a median particle distribution (D₅₀) of from 50 to 70 μm; and
(b) sintering the admixture obtained in step (a).

According to a second aspect of the present invention, there is provided a glass-ceramic material comprising from 50 to 70 wt % of silicon dioxide, from 5 to 10 wt % of aluminium oxide and from 5 to 10 wt % of calcium oxide; wherein the glass-ceramic material comprises less than 35 wt % of cristobalite and more than 35 wt % of pyroxene (for example diopside).

According to a third aspect of the present invention, there is provided a use of a glass-ceramic material obtained or obtainable by the method of the first aspect of the present invention or according to the second aspect of the invention in construction.

According to a fourth aspect of the present invention, there is provided a product formed from the glass-ceramic material according to the second aspect of the invention.

According to a fifth aspect of the present invention, there is provided a glass-ceramic material obtained or obtainable by the first aspect of the present invention.

According to a sixth aspect of the present invention, there is provided a product formed from the glass-ceramic material according to the fifth aspect of the invention.

The compositions and methods of the present invention provide an alternative to traditional ceramic materials, which are typically synthesised at or use much higher temperatures. The glass-ceramic material of the present invention further maintains acceptable mechanical properties, such as high compressive strength and/or desirable flexural strength.

### DETAILED DESCRIPTION OF THE INVENTION

Unless otherwise stated, the following terms used in the specification and claims have the meanings set out below.

The first aspect of the present invention provides a method of preparing a glass-ceramic material, the method comprising the steps of:
(a) admixing a crystallisation promoter and a glass; wherein the glass has a median particle distribution (D₅₀) of from 50 to 70 μm; and
(b) sintering the admixture obtained in step (a).

In the present invention, a glass-ceramic material is defined as having its typical meaning as would be well known to persons skilled in the art. For example, a glass-ceramic material may be 95 to 98% crystalline by volume.

In the present invention, glass is defined as having its typical meaning, i.e., a solid formed by rapid melt quenching. The glass may alternatively be referred to as vitreous solid. Suitably the glass may be a quartz-based glass, such as a soda-lime glass.

As will be known by the skilled person, the chemical composition of glass may be determined by X-ray fluorescence.

Glass may comprise one or more oxide compounds, for example one or more oxide compounds selected from silicon dioxide (SiO₂), aluminium oxide (Al₂O₃), calcium oxide (CaO), iron oxide (Fe₂O₃), magnesium oxide (MgO), sodium oxide (Na₂O), potassium oxide (K₂O), and titanium dioxide (TiO₂).

Suitably, the glass may have a silicon dioxide content of up to 90 wt %, suitably up to 85 wt % or 80 wt %, for example up to 75 wt %, based on the total weight of the glass. Suitably, the glass may have a silicon dioxide content of at least 40 wt %, suitably at least 45 wt % or 50 wt %, for example at least 55 wt % or at least 60 wt %, based on the total weight of the glass. Suitably, the glass may have a silicon dioxide content of from 40 wt % to 90 wt %, for example from 45 wt % to 85 wt % or from 50 wt % to 80 wt %, such as from 60 wt % to 75 wt %, based on the total weight of the glass.

Suitably, the glass may have a sodium oxide content of up to 30 wt %, suitably up to 25 wt % or 20 wt %, for example up to 15 wt %, based on the total weight of the glass. Suitably, the glass may have a sodium oxide content of at least 2 wt %, suitably at least 5 wt % or 7 wt %, for example at least 10 wt %, based on the total weight of the glass. Suitably, the glass may have a sodium oxide content of from 2 to 30 wt %, for example from 5 wt % to 25 wt % or from 7 wt % to 20 wt %, such as from 10 wt % to 15 wt %, based on the total weight of the glass.

Suitably, the glass may have a calcium oxide content of up to 30 wt %, suitably up to 25 wt % or 20 wt %, for example up to 15 wt % or up to 12 wt %, based on the total weight of the glass. Suitably, the glass may have a calcium oxide content of at least 2 wt %, suitably at least 5 wt % or 7 wt %, for example at least 8 wt %, based on the total weight of the glass. Suitably, the glass may have a calcium oxide content of from 2 wt % to 30 wt %, for example from 5 wt % to 25 wt % or from 7 wt % to 20 wt %, such as from 8 wt % to 15 wt % or 8 wt % to 12 wt %, based on the total weight of the glass.

Suitably, the glass may have an aluminium oxide content of from 0.5 wt % to 5 wt %, for example from 1 wt % to 4 wt % or from 1.5 wt % to 3 wt %, based on the total weight of the glass.

Suitably, the glass may have a potassium oxide content of from 0.1 wt % to 3 wt %, for example from 0.2 wt % to 2 wt % or from 0.3 wt % to 1 wt %, based on the total weight of the glass.

Suitably, the glass may have a silicon dioxide content of from 50 wt % to 80 wt % and a sodium oxide content of from 7 wt % to 20 wt %, based on the total weight of the glass.

Suitably, the glass may have a silicon dioxide content of from 50 wt % to 80 wt %, a sodium oxide content of from 7 wt % to 20 wt % and a calcium oxide content of from 8 wt % to 15 wt %, based on the total weight of the glass.

The pH of the glass (when dissolved in water) is suitably from 9 to 13, for example from 10 to 12, such as about 11. The pH may be measured using a PH meter.

Suitably, the glass has a specific surface area (SSA) determined by the Blaine air-permeability method of from 2 to 3 m²/g and/or a density of from 2.3 to 2.6 g/cm³. Methods of determining specific surface area and density are well-known to those skilled in the art. Suitably, the specific surface area may be determined according to a method of standard BS EN 196-6:2018. The density may be determined using a Quantachrome gas expansion multi-pycnometer purged with helium gas.

The composition of the glass may be analysed by powder X-ray diffraction (XRD). Suitably, the XRD analysis may indicate the absence of crystalline phases. Suitably, the XRD analysis may indicate the presence of an amorphous phase. Suitably, the XRD analysis may indicate the presence of an amorphous phase of plagioclase feldspar series, including andesine, labradorite ((Na, Ca) Al₁₋₂Si₃₋₂O₈).

The glass has a median particle size distribution (D₅₀) of from 50 to 70 μm.

Alternatively or additionally, the glass may have a D₁₀ distribution of from 5 to 10 μm.

Alternatively or additionally, the glass may have a Deo distribution of from 220 to 240 μm.

Methods of determining the median particle diameter and particle size distribution of particles are well-known to those skilled in the art. For example, the particle size distribution may be determined using a mesh sieve. The particle size distribution may be determined using a laser particle size analyser. As will be known by the skilled person, a laser particle size analyser measures the angular variation in intensity of light scattered as a laser beam passes through a dispersed particulate sample to obtain the particle size distribution.

The glass is suitably waste glass, for example crushed waste glass (CWG). CWG is a powdered waste glass that results from waste of bottles, jars and cups. Waste glass, which is sometimes also called cullet, is commonly found in mixed waste. For example, the CWG may be a commercially available blast grit. The waste glass, such as crushed waste glass, may comprise the oxide compounds as discussed herein in relation to glass generally, and in the proportions stated.

In step (a) of the method the glass is admixed with a crystallisation promoter.

The crystallisation promoter may also be referred to as a nucleating agent or sintering agent. Any suitable crystallisation promoter may be used. For example, the crystallisation promoter may comprise an oxide compound such as TiO₂, B₂O₃ or Li₂O.

The crystallisation promoter may comprise one or more oxide compounds selected from silicon dioxide (SiO₂), aluminium oxide (Al₂O₃), calcium oxide (CaO), iron oxide (Fe₂O₃), magnesium oxide (MgO), sodium oxide (Na₂O), potassium oxide (K₂O), and titanium dioxide (TiO₂).

The crystallisation promoter may comprise silicon dioxide (SiO₂), aluminium oxide (Al₂O₃), calcium oxide (CaO), iron oxide (Fe₂O₃), magnesium oxide (MgO), sodium oxide (Na₂O), potassium oxide (K₂O), and titanium dioxide (TiO₂). The crystallisation promoter may consist essentially of or consist of silicon dioxide (SiO₂), aluminium oxide (Al₂O₃), calcium oxide (CaO), iron oxide (Fe₂O₃), magnesium oxide (MgO), sodium oxide (Na₂O), potassium oxide (K₂O), and titanium dioxide (TiO₂).

Whilst the glass and the crystallisation promoter may each comprise oxide compounds, they have different overall compositions.

The crystallisation promoter may comprise silicon dioxide (SiO₂) and/or aluminium oxide (Al₂O₃). Suitably, the crystallisation promoter may have a silicon dioxide content of up to 35 wt %, suitably up to 40 wt % or 50 wt %, for example up to 55 wt % or up to 60 wt %, such as up to 70 wt %. Suitably, the crystallisation promoter may have a silicon dioxide content of at least 20 wt %, for example at least 25 wt % or at least 30 wt %, such as at least 35 wt %. Suitably, the crystallisation promoter may have a silicon dioxide content of from 20 wt % to 70 wt %, for example from 25 wt % to 65 wt % or from 35 wt % to 55 wt %.

Suitably, the crystallisation promoter may have an aluminium oxide content of up to 20 wt % or 25 wt %, for example up to 30 wt % or up to 40 wt %, such as up to 45 wt % or 50 wt %. Suitably, the crystallisation promoter may have an aluminium oxide content of at least 10 wt %, such as for example 15 wt % or for example at least 20 wt %. Suitably, the crystallisation promoter may have an aluminium oxide content of from 10 wt % to 50 wt %, for example from 15 wt % to 45 wt % or from 20 wt % to 40 wt %.

Suitably, the crystallisation promoter content comprises a majority of aluminium oxide and silicon dioxide, for example the crystallisation promoter content may comprise more than 50 wt % aluminium oxide and silicon dioxide (i.e., more than 50 wt % of the crystallisation promoter may be comprised of calcium oxide and silicon dioxide), for example more than 55 wt % aluminium oxide and silicon dioxide, such as more than 60 wt % aluminium oxide and silicon dioxide.

The crystallisation promoter content may comprise up to 85 wt %, such as up to 80 wt %, of aluminium oxide and silicon dioxide (i.e., up to 85 wt % or 80 wt % of the crystallisation promoter may be comprised of calcium oxide and silicon dioxide).

The crystallisation promoter may also comprise calcium oxide (CaO) and/or iron oxide (Fe₂O₃). The crystallisation promoter may comprise one or more additional oxide compounds, for example one or more oxide compounds selected from magnesium oxide (MgO), sodium oxide (Na₂O), potassium oxide (K₂O), and titanium dioxide (TiO₂).

Suitably, the crystallisation promoter may have a calcium oxide content of up to 10 wt %, such as up to 5 wt %. Suitably, the crystallisation promoter may have a calcium oxide content of at least 2 wt %, such as at least 4 wt %. Suitably, the crystallisation promoter may have a calcium oxide content of from 2 wt % to 10 wt %, for example from 1 wt % to 5 wt %.

Suitably, the crystallisation promoter may have an iron oxide content of up to 10 wt %, such as up to 5 wt %. Suitably, the crystallisation promoter may have an iron oxide content of at least 2 wt %, such as at least 4 wt %. Suitably, the crystallisation promoter may have an iron oxide content of from 2 wt % to 10 wt %, for example from 1 wt % to 5 wt %.

Suitably, the crystallisation promoter may have a sodium oxide content of up to 10 wt %, such as up to 5 wt %. Suitably, the crystallisation promoter may have a sodium oxide content of at least 2 wt %, such as at least 4 wt %. Suitably, the crystallisation promoter may have a sodium oxide content of from 2 wt % to 10 wt %, for example from 1 wt % to 5 wt %.

Suitably, the crystallisation promoter may have a magnesium oxide content of up to 10 wt %, such as up to 5 wt %. Suitably, the crystallisation promoter may have a magnesium oxide content of at least 2 wt %, such as at least 4 wt %. Suitably, the crystallisation promoter may have a magnesium oxide content of from 2 wt % to 10 wt %, for example from 1 wt % to 5 wt %.

Suitably, the crystallisation promoter may have a potassium oxide content of up to 4 wt %, such as up to 5 wt % or up to 8 wt %, suitably up to 10 wt %. Suitably, the crystallisation promoter may have a potassium oxide content of at least 1 wt %, suitably at least 4 wt %. Suitably, the crystallisation promoter may have a potassium oxide content of from 1 to 10 wt %, for example from 4 to 8 wt %.

Suitably the crystallisation promoter is natural pozzolan (NP). Natural pozzolan is otherwise known as volcanic tuff. Natural pozzolan is formed by the quenching of molten magma when it is projected to the atmosphere upon explosive volcanic eruptions. NP is suitably a source of aluminosilicate. NP suitably comprises aluminium oxide and silicon dioxide.

Suitably, the NP may have a silicon dioxide content of up to 35 wt %, suitably up to 40 wt % or 50 wt %, for example up to 55 wt % or up to 60 wt %, such as up to 70 wt %. Suitably, the NP may have a silicon dioxide content of at least 20 wt %, for example at least 25 wt % or at least 30 wt %, such as at least 35 wt %. Suitably, the NP may have a silicon dioxide content of from 20 wt % to 70 wt %, for example from 25 wt % to 65 wt % or from 35 wt % to 55 wt %.

Suitably, the NP may have an aluminium oxide content of up to 20 wt % or 25 wt %, for example up to 30 wt % or up to 40 wt %, such as up to 45 wt % or 50 wt %. Suitably, the NP may have an aluminium oxide content of at least 10 wt %, such as for example 15 wt % or for example at least 20 wt %. Suitably, the NP may have an aluminium oxide content of from 10 wt % to 50 wt %, for example from 15 wt % to 45 wt % or from 20 wt % to 40 wt %.

Suitably, the NP comprises a majority of aluminium oxide and silicon dioxide, for example the NP may comprise more than 50 wt % aluminium oxide and silicon dioxide (i.e., more than 50 wt % of the NP is comprised of calcium oxide and silicon dioxide), for example more than 55 wt % aluminium oxide and silicon dioxide, such as more than 60 wt % aluminium oxide and silicon dioxide.

The NP may comprise up to 85 wt %, such as up to 80 wt %, of aluminium oxide and silicon dioxide (i.e., up to 85 wt % or 80 wt % of the NP may be comprised of calcium oxide and silicon dioxide).

The NP may also comprise calcium oxide (CaO) and/or iron oxide (Fe₂O₃). The NP may comprise one or more additional oxide compounds, for example one or more oxide compounds selected from magnesium oxide (MgO), sodium oxide (Na₂O), potassium oxide (K₂O), and titanium dioxide (TiO₂).

Suitably, the NP may have a potassium oxide content of up to 4 wt %, such as up to 5 wt % or up to 8 wt %, suitably up to 10 wt %. Suitably, the NP may have a potassium oxide content of at least 1 wt %, suitably at least 4 wt %. Suitably, the NP may have a potassium oxide content of from 1 wt % to 10 wt %, for example from 4 to 8 wt %.

Suitably, the NP may have a calcium oxide content of up to 10 wt %, such as up to 5 wt %. Suitably, the NP may have a calcium oxide content of at least 2 wt %, such as at least 4 wt %. Suitably, the NP may have a calcium oxide content of from 2 wt % to 10 wt %, for example from 1 wt % to 5 wt %.

Suitably, the NP may have an iron oxide content of up to 10 wt %, such as up to 5 wt %. Suitably, the NP may have an iron oxide content of at least 2 wt %, such as at least 4 wt %. Suitably, the NP may have an iron oxide content of from 2 wt % to 10 wt %, for example from 1 wt % to 5 wt %.

Suitably, the NP may have a sodium oxide content of up to 10 wt %, such as up to 5 wt %. Suitably, the NP may have a sodium oxide content of at least 2 wt %, such as at least 4 wt %. Suitably, the NP may have a sodium oxide content of from 2 wt % to 10 wt %, for example from 1 wt % to 5 wt %.

Suitably, the NP may have a magnesium oxide content of up to 10 wt %, such as up to 5 wt %. Suitably, the NP may have a magnesium oxide content of at least 2 wt %, such as at least 4 wt %. Suitably, the NP may have a magnesium oxide content of from 2 wt % to 10 wt %, for example from 1 wt % to 5 wt %.

The NP may comprise silicon dioxide (SiO₂), aluminium oxide (Al₂O₃), calcium oxide (CaO), iron oxide (Fe₂O₃), magnesium oxide (MgO), sodium oxide (Na₂O), potassium oxide (K₂O), and titanium dioxide (TiO₂). The NP may consist essentially of or consist of silicon dioxide (SiO₂), aluminium oxide (Al₂O₃), calcium oxide (CaO), iron oxide (Fe₂O₃), magnesium oxide (MgO), sodium oxide (Na₂O), potassium oxide (K₂O), and titanium dioxide (TiO₂).

References herein to the oxide contents of the crystallisation promoter and the NP refer to the wt % based on the total weight of the crystallisation promoter or the NP respectively.

The crystallisation promoter and the NP disclosed herein may comprise the oxide compounds disclosed herein in any combination, including any combination of the amounts of each oxide compound thereof, as disclosed herein.

The pH of the NP (when dissolved in water) is suitably from 5 to 7, for example about 6.

Suitably, the NP has a specific surface area (SSA) determined by the Blaine air-permeability method of from 15 to 20 m²/g and/or a density of from 2.3 to 2.6 g/cm³.

Methods of determining specific surface area and density are well-known to those skilled in the art. Suitably, the specific surface area may be determined according to a method of standard BS EN 196-6:2018 using the Blaine air-permeability method. The density may be determined using a Quantachrome gas expansion multi-pycnometer purged with helium gas.

Suitably, in step (a), the glass and crystallisation promoter are admixed in a weight ratio of from 9:1 to 1:9. In one embodiment, the glass and crystallisation promoter are admixed in a weight ratio of 4:1. In one preferred embodiment, CWG and NP are admixed in a weight ratio of 4:1.

The resultant admixture obtained in step (a) may comprise from 10 wt % to 90 wt %, for example from 60 wt % to 90 wt %, of the glass, relative to the total weight of the admixture. For example, the resultant admixture obtained in step (a) may comprise from 10 wt % to 90 wt %, for example from 60 wt % to 90 wt %, of CWG, relative to the total weight of the admixture.

The resultant admixture obtained in step (a) may comprise from 10 wt % to 90 wt %, for example from 10 wt % to 40 wt %, of the crystallisation promoter, relative to the total weight of the admixture. For example, the resultant admixture obtained in step (a) may comprise from 10 wt % to 90 wt %, for example from 10 wt % to 40 wt %, of NP, relative to the total weight of the admixture.

Suitably, the resultant admixture obtained in step (a) comprises from 50 to 95 wt % of the glass and from 50 to 5 wt % of the crystallisation promoter. More suitably, the resultant admixture obtained in step (a) comprises from 60 to 90 wt % of the glass and from 40 to 10 wt % of the crystallisation promoter. For example, the resultant admixture obtained in step (a) may comprise from 60 to 90 wt % of CWG and from 40 to 10 wt % of NP.

Suitably, the resultant admixture obtained in step (a) comprises 10 wt % of the glass and 90 wt % of the crystallisation promoter. For example, the resultant admixture obtained in step (a) may comprise 10 wt % of CWG and 90 wt % of NP.

Suitably, the resultant admixture obtained in step (a) comprises 20 wt % of the glass and 80 wt % of the crystallisation promoter. For example, the resultant admixture obtained in step (a) may comprise 20 wt % of CWG and 80 wt % of NP.

Suitably, the resultant admixture obtained in step (a) comprises 30 wt % of the glass and 70 wt % of the crystallisation promoter. For example, the resultant admixture obtained in step (a) may comprise 30 wt % of CWG and 70 wt % of NP.

Suitably, the resultant admixture obtained in step (a) comprises 40 wt % of the glass and 60 wt % of the crystallisation promoter. For example, the resultant admixture obtained in step (a) may comprise 40 wt % of CWG and 60 wt % of NP.

Suitably, the resultant admixture obtained in step (a) comprises 50 wt % of the glass and 50 wt % of the crystallisation promoter. For example, the resultant admixture obtained in step (a) may comprise 50 wt % of CWG and 50 wt % of NP.

Suitably, the resultant admixture obtained in step (a) comprises 60 wt % of the glass and 40 wt % of the crystallisation promoter. For example, the resultant admixture obtained in step (a) may comprise 60 wt % of CWG and 40 wt % of NP.

Suitably, the resultant admixture obtained in step (a) comprises 70 wt % of the glass and 30 wt % of the crystallisation promoter. For example, the resultant admixture obtained in step (a) may comprise 70 wt % of CWG and 30 wt % of NP.

Suitably, the resultant admixture obtained in step (a) comprises 80 wt % of the glass and 20 wt % of the crystallisation promoter. For example, the resultant admixture obtained in step (a) may comprise 80 wt % of CWG and 20 wt % of NP.

Suitably, the resultant admixture obtained in step (a) comprises 90 wt % of the glass and 10 wt % of the crystallisation promoter. For example, the resultant admixture obtained in step (a) may comprise 90 wt % of CWG and 10 wt % of NP.

The glass and crystallisation promoter may be admixed by any suitable method. Suitably, the glass and crystallisation promoter are admixed by grinding, for example in a metal or ceramic grinding media. Preferably the glass and crystallisation promoter are admixed in a ceramic, for example a porcelain, grinding media. Suitably step (a) may be the step of grinding the glass and crystallisation promoter.

The glass and crystallisation promoter are suitably admixed for at least 10 minutes, for example at least 15 minutes or at least 20 minutes. For example, the glass and crystallisation promoter may be admixed for from 10 minutes to 30 minutes, for example 20 minutes.

The glass and crystallisation promoter may be admixed at any suitable temperature, including at ambient temperature.

In step (b), the admixture obtained in step (a) is sintered. As known by the skilled person, sintering is the process of forming a solid mass of material through heat and pressure without melting to the point of liquefaction.

Suitably, step (b) comprises sintering the admixture obtained in step (a) at a temperature of from 500 to 1500° C., for example from 600 to 1000° C., for example from 750 to 850° C., such as at a temperature of 800° C.

Step (b) suitably comprises sintering the admixture obtained in step (a) for up to 12 hours, for example up to 10 hours or up to 8 hours. For example, step (b) comprises sintering the admixture obtained in step (a) for up to 4 hours, such as for 2 hours.

Suitably, step (b) comprises sintering the admixture obtained in step (a) at a temperature of about 800° C. for 2 hours.

The inventors have surprisingly found that the sintering step (b) of the present invention occurs at a much lower temperature than methods of the prior art. This provides significant economic benefits.

The method of the first aspect of the present invention provides a glass-ceramic material. The fifth aspect of the present invention provides a glass-ceramic material obtained or obtainable by the method of the first aspect of the present invention.

The second aspect of the present invention provides a glass-ceramic material comprising from 50 wt % to 70 wt % of silicon dioxide, from 5 wt % to 10 wt % of aluminium oxide and from 5 wt % to 10 wt % of calcium oxide; wherein the glass-ceramic material comprises less than 35% of cristobalite and more than 35 wt % of pyroxene (for example diopside). The glass-ceramic material may be obtained or obtainable by the method of the first aspect of the invention. The skilled person would appreciate that the pyroxene may have any suitable upper limit depending on the amounts of the other components of the glass-ceramic material.

References herein to the glass-ceramic material may refer to the material obtained or obtainable by the method of the first aspect of the invention, or to the material of the second aspect of the invention, as appropriate unless one aspect in particular is specified.

The glass-ceramic material may comprise one or more oxide compounds, for example one or more oxide compounds selected from silicon dioxide (SiO₂), aluminium oxide (Al₂O₃), calcium oxide (CaO), iron oxide (Fe₂O₃), magnesium oxide (MgO), sodium oxide (Na₂O), potassium oxide (K₂O), and titanium dioxide (TiO₂).

The glass-ceramic material may comprise silicon dioxide (SiO₂), aluminium oxide (Al₂O₃), calcium oxide (CaO), iron oxide (Fe₂O₃), magnesium oxide (MgO), sodium oxide (Na₂O), potassium oxide (K₂O), and titanium dioxide (TiO₂).

Suitably, the glass-ceramic material may have a silicon dioxide content of up to 80 wt %, suitably up to 75 wt % or up to 70 wt %. Suitably, the glass-ceramic material may have a silicon dioxide content of at least 40 wt %, suitably at least 45 wt % or at least 50 wt %. Suitably, the glass-ceramic material may have a silicon dioxide content of from 40 wt % to 80 wt %, for example from 45 wt % to 75 wt % or from 50 wt % to 70 wt %.

Suitably, the glass-ceramic material may have an aluminium oxide content of up to 20 wt %, suitably up to 15 wt % or up to 10 wt %. Suitably, the glass-ceramic material may have an aluminium oxide content of at least 2 wt %, suitably at least 3 wt % or at least 5 wt %. Suitably, the glass-ceramic material may have an aluminium oxide content of from 2 wt % to 20 wt %, for example from 3 wt % to 15 wt % or from 7 wt % to 20 wt %, such as from 10 wt % to 15 wt %.

Suitably, the glass-ceramic material may have a calcium oxide content of up to 20 wt %, suitably up to 15 wt % or up to 10 wt %. Suitably, the glass-ceramic material may have a calcium oxide content of at least 2 wt %, suitably at least 3 wt % or at least 5 wt %. Suitably, the glass-ceramic material may have a calcium oxide content of from 2 wt % to 20 wt %, for example from 3 wt % to 15 wt % or from 7 wt % to 20 wt %, such as from 10 wt % to 15 wt %.

Suitably, the glass-ceramic material may have a sodium oxide content of up to 8 wt %, suitably up to 5 wt % or up to 3 wt %. Suitably, the glass-ceramic material may have a sodium oxide content of at least 0.5 wt %, suitably at least 1 wt %. Suitably, the glass-ceramic material may have a sodium oxide content of from 0.5 wt % to 8 wt %, for example from 0.5 wt % to 5 wt % or from 1 wt % to 5 wt %, such as from 1 wt % to 3 wt %.

Suitably, the glass-ceramic material may have a potassium oxide content of up to 10 wt %, suitably up to 8 wt % or up to 5 wt %. Suitably, the glass-ceramic material may have a potassium oxide content of at least 1.5 wt %, suitably at least 2 wt %. Suitably, the glass-ceramic material may have a potassium oxide content of from 1.5 wt % to 10 wt %, for example from 1.5 wt % to 8 wt % or from 2 wt % to 8 wt %, such as from 2 wt % to 5 wt %.

Suitably, the glass-ceramic material may have a titanium dioxide content of up to 1.5 wt %, suitably up to 1 wt % or up to 0.5 wt %. Suitably, the glass-ceramic material may have a titanium dioxide content of at least 0.1 wt %, suitably at least 0.2 wt %. Suitably, the glass-ceramic material may have a titanium dioxide content of from 0.1 wt % to 1.5 wt %, for example from 0.1 wt % to 1 wt % or from 0.1 wt % to 0.5 wt %, such as from 0.1 wt % to 0.2 wt %.

Suitably, the glass-ceramic material may have an iron oxide content of up to 3 wt %, suitably up to 2 wt % or up to 1.5 wt %. Suitably, the glass-ceramic material may have an iron oxide content of at least 0.5 wt %. Suitably, the glass-ceramic material may have an iron oxide content of from 0.5 wt % to 3 wt %, for example from 0.5 wt % to 2 wt % or from 0.5 wt % to 1.5 wt %.

Suitably, the glass-ceramic material may have a magnesium oxide content of up to 4 wt %, suitably up to 3 wt % or up to 2.5 wt %. Suitably, the glass-ceramic material may have a magnesium oxide content of at least 0.5 wt % or at least 1 wt %. Suitably, the glass-ceramic material may have a magnesium oxide content of from 0.5 wt % to 4 wt %, for example from 0.5 wt % to 3 wt % or from 0.5 wt % to 2.5 wt %, such as from 1 to 2.5 wt %.

Suitably, the glass-ceramic material may comprise less than 50 wt % of cristobalite, such as less than 40 wt % of cristobalite or less than 35 wt % of cristobalite, for example the glass-ceramic material may comprise about 30 wt % of cristobalite.

Suitably, the glass-ceramic material may comprise greater than 20 wt % of pyroxene (for example diopside), such as greater than 25 wt % of the pyroxene (for example diopside) or greater than 30 wt % of pyroxene (for example diopside), such as greater than 35 wt % of pyroxene (for example diopside), for example the glass-ceramic material may comprise about 40 wt % of pyroxene (for example diopside).

Suitably, the glass-ceramic material may comprise less than 50 wt % of plagioclase (for example albite), such as less than 40 wt % of plagioclase (for example albite) or less than 35 wt % of plagioclase (for example albite), for example the glass-ceramic material may comprise about 30 wt % of plagioclase (for example albite).

The glass-ceramic material of the second aspect of the present invention comprises from 50 wt % to 70 wt % of silicon dioxide, from 5 wt % to 10 wt % of aluminium oxide and from 5 wt % to 10 wt % of calcium oxide; and the glass-ceramic material comprises less than 35 wt % of cristobalite and more than 35 wt % of pyroxene (for example diopside).

The glass-ceramic material of the second aspect of the present invention may comprise one or more additional oxide compounds, for example one or more additional oxide compounds selected from iron oxide (Fe₂O₃), magnesium oxide (MgO), sodium oxide (Na₂O), potassium oxide (K₂O) and titanium dioxide (TiO₂). The glass-ceramic material of the second aspect of the present invention may additionally comprise iron oxide (Fe₂O₃), magnesium oxide (MgO), sodium oxide (Na₂O), potassium oxide (K₂O) and titanium dioxide (TiO₂).

In particular, the glass-ceramic material of the second aspect of the present invention has a silicon dioxide content of from 50 wt % to 70 wt %, such as from 55 wt % to 75 wt %.

In particular, the glass-ceramic material of the second aspect of the present invention has an aluminium oxide content of from 5 wt % to 10 wt %, such as from 6 wt % to 8 wt %.

In particular, the glass-ceramic material of the second aspect of the present invention has a calcium oxide content of from 5 wt % to 10 wt %, such as from 6 wt % to 10 wt %.

In particular, the glass-ceramic material of the second aspect of the present invention may have a sodium oxide content of up to 8 wt %, suitably up to 5 wt % or up to 3 wt %. Suitably, the glass-ceramic material of the second aspect of the present invention may have a sodium oxide content of at least 0.5 wt %, suitably at least 1 wt %. Suitably, the glass-ceramic material of the second aspect of the present invention may have a sodium oxide content of from 0.5 wt % to 8 wt %, for example from 0.5 wt % to 5 wt % or from 1 wt % to 5 wt %, such as from 1 wt % to 3 wt %.

In particular, the glass-ceramic material of the second aspect of the present invention may have a potassium oxide content of up to 10 wt %, suitably up to 8 wt % or up to 5 wt %. Suitably, the glass-ceramic material of the second aspect of the present invention may have a potassium oxide content of at least 1.5 wt %, suitably at least 2 wt %. Suitably, the glass-ceramic material of the second aspect of the present invention may have a potassium oxide content of from 1.5 wt % to 10 wt %, for example from 1.5 wt % to 8 wt % or from 2 wt % to 8 wt %, such as from 2 wt % to 5 wt %.

In particular, the glass-ceramic material of the second aspect of the present invention may have a titanium dioxide content of up to 1.5 wt %, suitably up to 1 wt % or up to 0.5 wt %. Suitably, the glass-ceramic material of the second aspect of the present invention may have a titanium dioxide content of at least 0.1 wt %, suitably at least 0.2 wt %. Suitably, the glass-ceramic material of the second aspect of the present invention may have a titanium dioxide content of from 0.1 wt % to 1.5 wt %, for example from 0.1 wt % to 1 wt % or from 0.1 wt % to 0.5 wt %, such as from 0.1 wt % to 0.2 wt %.

In particular, the glass-ceramic material of the second aspect of the present invention may have an iron oxide content of up to 3 wt %, suitably up to 2 wt % or up to 1.5 wt %. Suitably, the glass-ceramic material of the second aspect of the present invention may have an iron oxide content of at least 0.5 wt %. Suitably, the glass-ceramic material of the second aspect of the present invention may have an iron oxide content of from 0.5 wt % to 3 wt %, for example from 0.5 wt % to 2 wt % or from 0.5 wt % to 1.5 wt %.

In particular, the glass-ceramic material of the second aspect of the present invention may have a magnesium oxide content of up to 4 wt %, suitably up to 3 wt % or up to 2.5 wt %. Suitably, the glass-ceramic material of the second aspect of the present invention may have a magnesium oxide content of at least 0.5 wt % or at least 1 wt %. Suitably, the glass-ceramic material of the second aspect of the present invention may have a magnesium oxide content of from 0.5 wt % to 4 wt %, for example from 0.5 wt % to 3 wt % or from 0.5 wt % to 2.5 wt %, such as from 1 wt % to 2.5 wt %.

The glass-ceramic material of the second aspect of the present invention may have an oxide compound content as follows:
(i) silicon dioxide from 50 wt % to 70 wt %;
(ii) aluminium oxide from 5 wt % to 10 wt %;
(iii) calcium oxide from 5 wt % to 10 wt %;
(iv) sodium oxide from 1 wt % to 5 wt %;
(v) potassium oxide from 2 wt % to 8 wt %;
(vi) titanium dioxide from 0.1 wt % to 0.5 wt %;
(vii) iron oxide from 0.5 wt % to 2 wt %; and
(viii) magnesium oxide from 0.5 wt % to 2.5 wt %.

The glass-ceramic material of the second aspect of the present invention may have an oxide compound content as follows:
(i) silicon dioxide from 55 wt % to 75 wt %;
(ii) aluminium oxide from 6 wt % to 8 wt %;
(iii) calcium oxide from 6 wt % to 10 wt %;
(iv) sodium oxide from 1 wt % to 5 wt %;
(v) potassium oxide or from 2 wt % to 8 wt %;
(vi) titanium dioxide from 0.1 wt % to 0.5 wt %;
(vii) iron oxide from 0.5 wt % to 2 wt %; and
(viii) magnesium oxide from 0.5 wt % to 2.5 wt %.

The glass-ceramic material of the second aspect of the present invention may have an oxide compound content as follows:
(i) silicon dioxide from 55 wt % to 75 wt %;
(ii) aluminium oxide from 6 wt % to 8 wt %;
(iii) calcium oxide from 6 wt % to 10 wt %;
(iv) sodium oxide from 1 wt % to 3 wt %;
(v) potassium oxide from 2 wt % to 5 wt %;
(vi) titanium dioxide from 0.1 wt % to 0.2 wt %;
(Vii) iron oxide from 0.5 wt % to 1.5 wt %; and
(viii) magnesium oxide from 1 wt % to 2.5 wt %.

The glass-ceramic material of the second aspect of the present invention comprises less than 35 wt % of cristobalite, for example the glass-ceramic material may comprise about 30 wt % of cristobalite.

The glass-ceramic material of the second aspect of the present invention comprises more than 35 wt % pyroxene (for example diopside), for example the glass-ceramic material may comprise about 40 wt % of pyroxene (for example diopside).

Suitably, the glass-ceramic material of the second aspect of the present invention may comprise less than 50 wt % of plagioclase (for example albite), such as less than 40 wt % of plagioclase (for example albite) or less than 35 wt % of plagioclase (for example albite), for example the glass-ceramic material may comprise about 30 wt % of plagioclase (for example albite).

In one embodiment, the glass-ceramic material comprises from 50 to 70 wt % silicon dioxide, from 5 to 10 wt % aluminium oxide and from 5 to 10 wt % calcium oxide; wherein the glass-ceramic material comprises less than 35 wt % of cristobalite and more than 35 wt % of pyroxene (for example diopside).

References herein to the oxide contents of the glass-ceramic material refer to the wt % based on the total weight of the glass-ceramic material.

The glass-ceramic material may comprise the oxide compounds disclosed herein in any combination, including any combination of the amounts of each oxide compound thereof, as disclosed herein.

The glass-ceramic material (prepared or disclosed herein) suitably has a compressive strength of at least 10 MPa. In some embodiments the glass-ceramic material has a compressive strength of at least 50 MPa, suitably of at least 100 MPa. In some embodiments the glass-ceramic material has a compressive strength of at least 150 MPa, for example at least 200 MPa.

Compressive strength is the maximum compressive stress that, under a gradually applied load, a given solid material can sustain without fracture. Suitable methods of determining the compressive strength will be known to those skilled in the art. For example, the compressive strength may be determined by a method according to BS EN 196-1.

Suitably, the glass-ceramic material (prepared or disclosed herein) has a flexural strength of at least 5 MPa, for example of at least 10 MPa or at least 20 MPa. In some embodiments the glass-ceramic material has a flexural strength of at least 30 MPa, suitably at least 40 MPa, for example at least 50 MPa or at least 55 MPa. Suitably, the glass-ceramic material has a flexural strength of from 5 MPa to 100 MPa.

Suitable methods of determining the flexural strength will be known to those skilled in the art. For example, the flexural strength may be determined by a method according to BS EN 12390-5.

The glass-ceramic material (prepared or disclosed herein) suitably has a thermal expansion coefficient of from 0.1 to 100×10⁻⁶ K⁻¹, such as from 1 to 20×10⁻⁶ K⁻¹, for example 5 to 15×10⁻⁶ K⁻¹ at 25° C. Suitable methods of determining the thermal expansion coefficient will be known to these skilled in the art. For example, the thermal expansion coefficient may be measured using a dilatometer.

The glass-ceramic material (prepared or disclosed herein) suitably has an electrical conductivity of from 0.1 to 100×10¹⁰ Ωm, such as from 1 to 50×10¹⁰ Ωm, for example from 2 to 10×10¹⁰ Ωm. Suitable methods of determining the electrical conductivity will be known to those skilled in the art. For example, the electrical conductivity may be determined by a method according to BS EN 62631-3-1.

A third aspect of the present invention provides the use of glass-ceramic material obtained or obtainable by the method of the first aspect of the present invention or according to the second aspect of the present invention in construction.

A fourth aspect of the present invention provides a product formed from the glass-ceramic material according to the second aspect of the invention.

A fifth aspect of the present invention provides a glass-ceramic material obtained or obtainable by the first aspect of the present invention.

A sixth aspect of the present invention provides a product formed from the glass-ceramic material according to the fifth aspect of the invention.

For a better understanding of the invention, and to show how exemplary embodiments of the same may be carried into effect, reference will be made, by way of example only, to the accompanying diagrammatic Figures, in which:

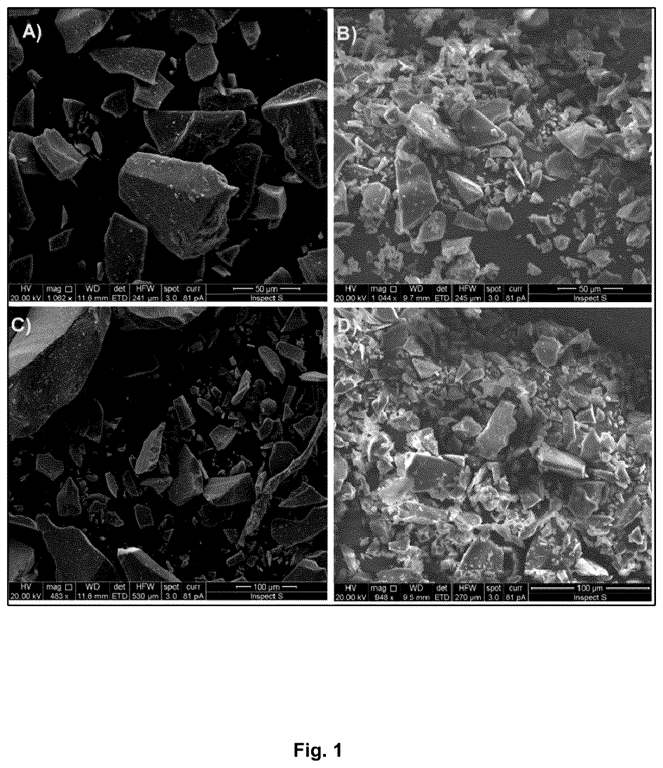

FIG. 1 shows a SEM micrograph with magnification 50 and 100 μm of CWG powder: a & c) unground CWG, b & d) ground CWG for 20 minutes.

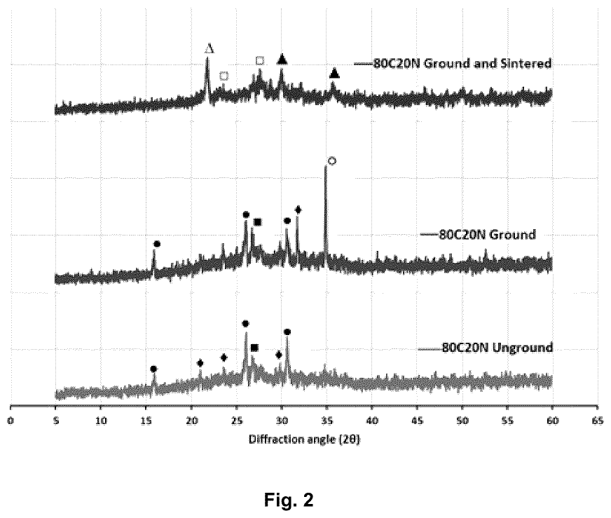

FIG. 2 shows X-ray diffraction patterns of the optimised blend (80C20N) before and after grinding and sintering. (●: Analcime, ▪: Sanidine, ♦: Quartz, ∘: Pyrope, Δ: Cristobalite, □: Albite, ▴: Diopside).

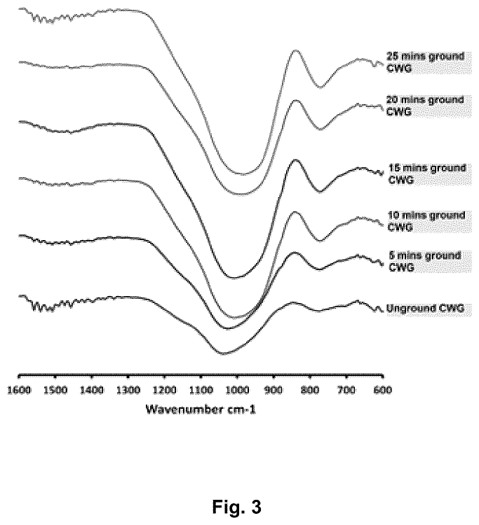

FIG. 3 shows an FTIR spectra of unground and ground CWG for 5 to 25 minutes.

### EXAMPLES

The invention will now be described with reference to the following non-limiting examples.

### Materials

A commercially available blast grit produced from waste glasses (obtained from a material recycling facility) was used as the glass. Natural pozzolan (NP) was used as the crystallisation promoter.

The chemical and physical characterisations of both raw materials are shown in Table 1.

TABLE 1

| | |
|---|---|
| CWG | NP |

Chemical Composition (wt %)

| | | |
|---|---|---|
| SiO₂ | 72.2 | 46.6 |
| Al₂O₃ | 1.5 | 30.4 |
| Fe₂O₃ | 0.07 | 3.8 |
| CaO | 10.9 | 4.5 |
| Na₂O | 13.3 | 3.9 |
| K₂O | 0.45 | 6 |
| MgO | 1.3 | 4.2 |
| TiO₂ | 0.06 | 0.6 |

Physical Properties

| | | |
|---|---|---|
| Specific surface area | 2.3 | 17.2 |
| (Blaine) (m²/g) | | |
| Density (g/cm³) | 2.53 | 2.57 |
| pH | 10.6 | 6 |

### Synthesis of Glass-Ceramic Materials

The CWG was ground for 20 minutes to obtain a median particle distribution (Ds) of from 50 to 70 μm. The NP and CWG were admixed in varying proportions (as shown in Table 2) and were homogenised for 10 minutes by grinding with a porcelain grinding media. The resultant admixture was put into crucibles in four layers, with manual compaction at each layer. Each crucible was covered with a plate and a load aid (brick) to avoid volume expansion problems. The covered crucibles were each placed in a muffle furnace and sintered at 800° C. with a holding time of 2 hours and a heating rate of 10° C./minute.

After the heating programme was completed, the crucibles were left to cool down, and the furnace was switched off. After the crucibles had cooled down, the obtained glass-ceramic material was extracted for testing and characterisation.

TABLE 2

| Mixture ID | 100C0N | 90C10N | 80C20N | 70C30N | 60C40N |
|---|---|---|---|---|---|
| CWG (wt %) | 100 | 90 | 80 | 70 | 60 |
| NP (wt %) | 0 | 10 | 20 | 30 | 40 |

Mixture 100C0N is provided as a comparative example. Mixtures 90C10N; 80C20N; 70C30N; and 60C40N are according to the invention.

Table 3 shows the compressive strength for each example.

TABLE 3

| Mixture ID | 100C0N | 90C10N | 80C20N | 70C30N | 60C40N |
|---|---|---|---|---|---|
| Compressive | 43.45 | 53.8 | 245.85 | 143.2 | 49.75 |
| Strength | | | | | |
| (MPa) | | | | | |

The compressive strength of each of the glass-ceramic materials is displayed in Table 3. Example 80C20N achieved maximum solidification and densification compared to unground samples. All Examples showed an improvement in compressive strength compared to the comparative example.

As can be seen in Table 3, 20 wt % of NP triggered the optimum level of crystallisation, leading to the creation of more crystals, which acted as a reinforcement to the glassy matrix and inhibited the glass from undergoing self-crystallisation. The resulting product had the highest compressive strength (245.85 MPa).

The compressive strength data for the 80C20N with different grinding times are shown in Table 4.

TABLE 4

| | | | | | | |
|---|---|---|---|---|---|---|
| Grinding Time (minutes) | 0 | 5 | 10 | 15 | 20 | 25 |
| Compressive Strength | 67.4 | 189.8 | 193.0 | 201.0 | 245.85 | 110.0 |
| (MPa) | | | | | | |

The strength values increased sharply to 189.8 MPa after only 5 minutes of CWG grinding, a growth percentage of 181% compared to the unground sample, which had a strength of only 67.4 MPa. Significant growth as well as optimum strength was observed in the sample prepared with CWG ground for 20 minutes (245 MPa). This indicates that grinding the CWG for 20 min increased the melting and interacting reactions of particles during sintering.

Based on the results in Table 4, the strength of glass-ceramics is very sensitive to changes in particle size due to grinding treatment, which reveals a highly sensitive crystallinity and microstructure. It is thought that decreasing the particle size by grinding contributes to an increased filling of densified gel generated from a complete reaction between the CWG and substrates of Ca—Mg—Al—Si from the NP that decreases porous materials and produces ceramic phases.

The effect of 20 minutes grinding on the CWG particles examined by the SEM is evidently observed in the micrographs in FIG. 1. FIG. 1 is shows that particle size of CWG after grinding for 20 minutes has reduced.

To explore the influence of sintering temperature, Example 80C20N containing CWG particles ground for 20 minutes was sintered at temperatures in the range of 700 to 900° C., with an increment of 50° C., and their compressive strength was measured, as shown in Table 5.

TABLE 5

| Temperature (° C.) | 700 | 750 | 800 | 850 |
|---|---|---|---|---|
| Compressive | 85.8 | 171.8 | 245.85 | 63.7 |
| Strength | | | | |
| (MPa) | | | | |

To examine the influence of optimised grinding (20 min) and sintering (800° C.) on the phase composition of Example 80C20N, a further comparative powder XRD was conducted as shown in FIG. 2.

The predominant diffraction phase in the unground mix was analcime at primarily 2θ 16, 26 and 30.6, a phase that was also notably present in the NP diffractions. In addition, sanidine peaks were observed as a second crystalline diffraction phase that was distributed through several diffraction angles along with minor quantities of crystalline quartz. The notable transformation of the analcime and sanidine phases to a remarkable pyrope crystal [Mg₃Al₂(SiO₄)₃] at 2θ 34.8 reveals that comminution of both the CWG and the NP introduced chemical transformation within the internal matrix of the blend. The transformation is clarified by the reduction and even disappearance of both analcime and sanidine minerals from the blend just after grinding.

Furthermore, cristobalite appeared as an observable but lower peak, and there were wide, diffusive phases of diopside and albite, which are the key nucleation products that supply the development of strength and advanced physical-chemical properties. The phase evolution after sintering showed a significant change in the phases; new products appeared because of the crystallisation temperature treatment.

The infrared spectra of the unground and ground CWG powder for grinding times 5-25 minutes are illustrated in FIG. 3. The spectra are revealing a broad band around 1000 cm⁻¹ which is related to the symmetric stretching vibration induced by the Si—O tetrahedra, and the signal at 775-800 cm⁻¹ is associated with the Si—O—Si bridged stretching between tetrahedra. The formulation of more Si—O bonds is resulting from the destruction of the crystal lattice or the vitreous grid which produces numerous raptures of the internal compensated chemical bonds to be transformed to non-compensated bonds. It is thought that the more non-compensated bonds, the more active are the glass powder to participate in the chemical mechanism of glass-ceramic production, crystallizing, adsorption capabilities.

The composition of Example 80C20N, sintered at 800° C. and comprising CWG ground for 20 minutes, is shown in Table 6 below.

TABLE 6

| Oxide | SiO₂ | Al₂O₃ | Fe₂O₃ | CaO | Na₂O | K₂O | MgO | TiO₂ |
|---|---|---|---|---|---|---|---|---|
| Wt % | 62.6 | 7.1 | 1 | 9.2 | 1.6 | 2.3 | 2 | 0.3 |

Table 7 shows a comparison of the properties of Example 80C20N, sintered at 800° C. and comprising CWG ground for 20 minutes, with granite.

Thermal expansion was determined using a NETZSCH DIL 402 C Dilatometer. Example 80C20N was tested with a size of 8 mm×8 mm×20 mm for temperature up to 1000° C. and heating rate 10° C./min.

The electrical conductivity (or resistivity) was determined based on the industrial standard BS EN 62631-3-1.

The flexural strength was determined based on the industrial standard BS EN 12390-5 for a prism of dimensions of 160 mm×40 mm×40 mm, based on loading system of a centre-point which has higher consistency by 13% than two-point loading.

TABLE 7

| | | |
|---|---|---|
| Properties | 80C20N | Granite |

| Porosity (%) | 3.1 | | 0.1-4.0 |
|---|---|---|---|
| Density (g/cm³) | 2.27 | | 2.5 |
| Rockwell hardness (HRB) | 100 | | 90 |
| Compressive strength (MPa) | 242.6 | | 200 |
| Flexural strength (MPa) | 52 | | 10 |
| Electrical resistivity (Ωm) | 5.8 × 10¹⁰ | | Max. 5 × 10³ |
| Thermal Expansion (K⁻¹) | 10.6 × 10⁻⁶ | (28 to 500° C.) | |
| | 14 × 10⁻⁶ | (28 to 900° C.) | |

Although a few preferred embodiments have been shown and described, it will be appreciated by those skilled in the art that various changes and modifications might be made without departing from the scope of the invention, as defined in the appended claims.

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention. Typically, when referring to compositions, a composition consisting essentially of a set of components will comprise less than 5% by weight, typically less than 3% by weight, more typically less than 1% by weight of non-specified components.

For the avoidance of doubt, wherein amounts of components in a composition are described in wt %, this means the weight percentage of the specified component in relation to the whole composition referred to. For example, “the resultant admixture obtained in step (a) may comprise from 10 wt % to 90 wt % of CWG” means that 10 to 90 wt % of the admixture is provided by CWG.

The optional features set out herein may be used either individually or in combination with each other where appropriate and particularly in the combinations as set out in the accompanying claims. The optional features for each aspect or exemplary embodiment of the invention as set out herein are also to be read as applicable to any other aspect or exemplary embodiments of the invention, where appropriate. In other words, the skilled person reading this specification should consider the optional features for each exemplary embodiment of the invention as interchangeable and combinable between different exemplary embodiments.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, and drawings), and/or all of the steps of any method or process so disclosed, may be combined in any combination, except combinations where at least some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, and drawings), or to any novel one, or any novel combination, of the steps of any method or process so disclosed.

1. A method of preparing a glass-ceramic material, the method comprising the steps of:
(a) admixing a crystallisation promoter and a glass; wherein the glass has a median particle distribution (D50) of from 50 to 70 μm; and
(b) sintering the admixture obtained in step (a).

2. The method according to claim 1, wherein the glass has a silicon dioxide content of from 60 wt % to 75 wt % and/or a sodium oxide content of from 10 wt % to 15 wt % and/or a calcium oxide content of from 8 wt % to 12 wt %.

3. The method according to claim 1, wherein the glass has a pH of from 10 to 12 in aqueous solution.

4. The method according to claim 1, wherein the glass has a D10 distribution of from 5 to 10 μm and/or a D90 distribution of from 220 to 240 μm.

5. The method according to claim 1, wherein the glass is crushed waste glass (CWG).

6. The method according to claim 1, wherein the crystallisation promoter is natural pozzolan (NP).

7. The method according to claim 6, wherein the NP has a silicon dioxide content of from 35 wt % to 55 wt % and/or an aluminium oxide content of from 20 wt % to 40 wt % and/or a potassium oxide content of from 4 wt % to 8 wt %.

8. The method according to claim 6, wherein the pH of the NP is from 5 to 7 in aqueous solution.

9. The method according to claim 1, wherein the glass and the crystallisation promoter are admixed in a weight ratio of from 9:1 to 1:9, suitably in a ratio of from 9:1 to 3:1.

10. The method according to claim 1, wherein step (a) comprises grinding the glass and the crystallisation promoter.

11. The method according to claim 1, wherein in step (a) the glass and crystallisation promoter are admixed for from 10 minutes to 30 minutes, suitably 20 minutes.

12. The method according to claim 1, wherein step (b) comprises sintering the admixture obtained in step (a) at a temperature of from 750 to 850° C.

13. A glass-ceramic material comprising from 50 to 70 wt % of silicon dioxide, from 5 to 10 wt % of aluminium oxide and from 5 to 10 wt % of calcium oxide; wherein the glass-ceramic material comprises less than 35 wt % of cristobalite and more than 35 wt % of pyroxene.

14. The glass-ceramic material according to claim 13, wherein the glass-ceramic material has a compressive strength of at least 50 MPa.

15. The glass-ceramic material according to claim 13, wherein the glass-ceramic material has a flexural strength of at least 20 MPa.

16. A method of using a glass-ceramic material comprising:
forming a glass-ceramic material according to claim 13; and
using the glass-ceramic material in construction.

17. A product formed from the glass-ceramic material according to claim 13.

18. A glass-ceramic material obtained or obtainable by the method of claim 1.
